(19) United States
(12) Patent Application Publication
(10) Pub. No.: US 2023/0410141 A1
(43) Pub. Date: Dec. 21, 2023

(54) SALES DATA PROCESSING APPARATUS AND SALES DATA PROCESSING SYSTEM

(71) Applicant: Toshiba Tec Kabushiki Kaisha, Tokyo (JP)

(72) Inventor: Yoshihiro KARITA, Fukoka Fukuoka (JP)

(21) Appl. No.: 18/175,202

(22) Filed: Feb. 27, 2023

(30) Foreign Application Priority Data
May 25, 2022 (JP) 2022-085205

(51) Int. Cl. G06Q 30/0238; G06Q 30/0226

(52) U.S. Cl. CPC G06Q 30/0238; G06Q 30/0226

(57) ABSTRACT

According to one embodiment, a sales data processing apparatus includes a communication interface to connect to a server and a processor. The processor is configured to receive customer identification information for identifying a customer in a sales transaction and commodity identification information for identifying a commodity in the sales transaction. The processor acquires privilege information from the server indicating a privilege associated with the customer for the purchase of a specified commodity. The processor is further configured to receive a privilege use instruction for declaring an intention by the customer to purchase the specified commodity using the privilege and register the commodity in the sales transaction at a discounted price if the commodity is the specified commodity, the privilege use instruction declares the intention to purchase the specified commodity using the privilege, and the privilege associated with the customer satisfies a privilege condition set for the specified commodity.

### CROSS-REFERENCE TO RELATED APPLICATION

This application is based upon and claims the benefit of priority from Japanese Patent Application No. 2022-085205, filed May 25, 2022, the entire contents of which are incorporated herein by reference.

### FIELD

Embodiments described herein relate generally to a sales data processing apparatus and a sales data processing system.

### BACKGROUND

There are some stores that perform a service or provide a discount on a product based on accumulation of privilege stickers for the purpose of sales promotion or the like. In this type of system, whenever a customer purchases a service target commodity in a store, a privilege sticker is granted to the customer according to a purchase amount of the service target commodity or the like. When the number of accumulated privilege stickers reaches a certain number, the service or discount is provided to the customer at the time of the next purchase or the like.

In order to implement such a system, the customer needs to manage all the privilege stickers received from the store, and the store needs to physically give the privilege stickers to the customer at each checkout as appropriate, which can be troublesome for both the customer and the store.

### BRIEF DESCRIPTION OF THE DRAWINGS

FIG. 1 is a diagram schematically illustrating a sales data processing system according to a first embodiment.

FIG. 2 is a block diagram of a server device according to the first embodiment.

FIG. 3 is a diagram illustrating a data configuration of a commodity master stored in a server device.

FIG. 4 is a diagram illustrating a data configuration of a privilege condition table stored in a server device.

FIG. 5 is a diagram illustrating a data configuration of a privilege management table stored in a server device.

FIG. 6 is a block diagram illustrating functional aspects of a control unit.

FIG. 7 is a block diagram of a POS terminal.

FIG. 8 is a block diagram illustrating functional aspects of a control unit.

FIG. 9 is a flowchart illustrating payment processing executed by a control unit.

FIG. 10 is a diagram illustrating a privilege use instruction screen displayed on a display unit.

FIG. 11 is a diagram illustrating a display screen at the time of settlement.

FIG. 12 is a diagram illustrating a receipt issued by a POS terminal.

FIG. 13 is a flowchart illustrating privilege sticker change processing executed by a control unit.

FIG. 14 is a diagram illustrating a privilege sticker addition screen displayed on a display unit.

FIG. 15 is a diagram illustrating a privilege receipt issued by a POS terminal.

FIG. 16 is a flowchart of privilege sticker change processing executed by a control unit of a POS terminal according to a second embodiment.

FIG. 17 is a diagram illustrating a preset screen displayed on a display unit.

FIG. 18 is a flowchart of exchange payment processing executed by a control unit.

### DETAILED DESCRIPTION

In general, a sales data processing apparatus and a sales data processing system which represent technological solutions to problems found in the use and provision of existing privilege sticker promotional programs and systems.

According to one embodiment, a sales data processing apparatus includes a communication interface to connect to a store server or the like and a processor. The processor is configured to receive customer identification information for identifying a customer in a sales transaction; receive commodity identification information for identifying a commodity in the sales transaction; acquire privilege information from the server indicating a privilege associated with the customer for the purchase of a specified commodity; receive a privilege use instruction for declaring an intention by the customer to purchase the specified commodity using the privilege; and register the commodity in the sales transaction at a discounted price if the commodity is the specified commodity, the privilege use instruction declares the intention to purchase the specified commodity using the privilege, and the privilege associated with the customer satisfies a privilege condition set for the specified commodity.

Hereinafter, a sales data processing apparatus and a sales data processing system according to certain, non-limiting example embodiments will be described with reference to the drawings. In the described example embodiments, a privilege sticker is granted to a customer for purchases above a certain value. When a purchase transaction is a multiple of the certain value, multiple privilege stickers may be granted for the same transaction. In these examples, the accumulated privilege stickers permit the purchase of a specified commodity, but the embodiments are not limited to these examples. In other examples, the privilege may be points granted at a predetermined ratio to the purchase amount and the accumulated privilege stickers may provide a discount in a subsequent transaction.

In the described example embodiments, the sales data processing system is applied to a single store, but the present disclosure is not limited thereto. The sales data processing system may be constructed across, and shared by, a plurality of stores. In such a case, a point of sales (POS) terminal provided in each store can be used as the sales data processing apparatus, and a head office server of a company that operates the plurality of stores can be used as a server device.

### First Embodiment

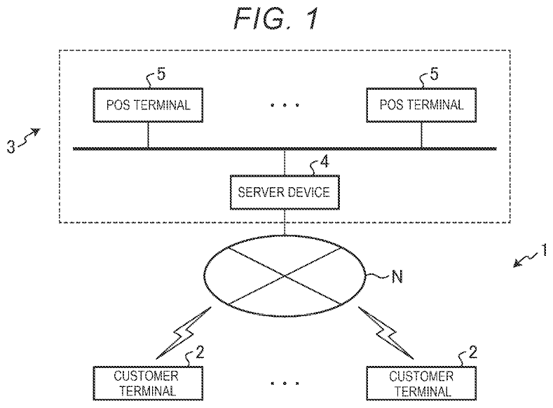

FIG. 1 is a diagram schematically illustrating a store system 1 including a sales data processing system. The store system 1 according to the first embodiment is applied to, for example, a store such as a supermarket that sells food, clothing, daily necessities, and the like.

The store system 1 includes customer terminals 2 and a sales data processing system 3. Each customer terminal 2 is an information terminal such as a smartphone, a tablet terminal, or a personal computer (PC) held by a customer who is a member registered or otherwise qualified for a privilege service. An application program for the privilege service is installed in the customer terminal 2.

The sales data processing system 3 includes a server device 4 and a plurality of POS terminals 5. The server device 4 and the POS terminals 5 are communicably connected to each other via a network such as a local area network (LAN). The server device 4 is communicably connected to the customer terminals 2 via a network N such as the Internet. The number of the customer terminals 2 and the number of the POS terminals 5 are not limited to the illustrated example.

The server device 4 functions as a store server that manages (tracks) various types of information for the store. For example, the server device 4 receives, from each POS terminal 5, purchase information including commodity information of a commodity for which payment has been performed in payment processing and settlement information related to a settlement method and the like. In addition, the server device 4 receives sales information indicating a sales amount (sales total) over a predetermined period (for example, one day) from each POS terminal 5. The server device 4 manages the purchase information, the sales information, and the like received from each POS terminal 5, and performs sales management and the like in one store. Further, the server device 4 appropriately updates a commodity master that stores information related to commodities sold in the store, and transmits the updated commodity master to each POS terminal 5. In addition, the server device 4 stores information related to the privilege service, and transmits such information to each POS terminal 5 as necessary.

The server device 4 also manages, for each customer, the number of privilege stickers granted to the customer in response to purchases of a service target commodity. The privilege sticker in this context is electronic data granted based on a certain purchase amount. For example, one privilege sticker is granted for every 1,000 yen worth purchases of service target commodities. The privilege stickers may be used for purchasing a specified commodity at a discount or the like.

When the number of privilege stickers held by a customer reaches a certain number, the customer can purchase a specified commodity at a discount price. For example, once 10 privilege stickers are collected, the customer can purchase a specified commodity A at a discount price, and when 20 privilege stickers have been collected, the customer can purchase a specified commodity B at a discount price. The discount price or amount can be set separately for each specified commodity. In some example, discount price (price after discount) may be set to 0 yen, and in this case, the customer can exchange a certain number of privilege stickers to receive a specified commodity for free.

In addition to the privilege stickers, the server device 4 also manages points (e.g., customer loyalty reward points) to be granted to the customer in response to purchases of commodities. Such points may have a value equivalent to money at some fixed ratio and may be freely used in subsequent shopping. In general, these points are granted not only when a service target commodity is purchased but whenever any commodity in the store is purchased. The server device 4 manages the privilege stickers and the points for each customer. When the customer terminal 2 accesses the server device 4, the customer can browse information such as the number of privilege stickers and points held by the customer.

The POS terminal 5 is provided in the store and executes the payment processing related to payment for a commodity purchased by a customer. The POS terminal 5 is an example of a sales data processing apparatus. The POS terminal 5 may be a POS terminal for a salesclerk to perform operations related to commodity registration and payment processing or a self-service POS terminal for a customer to perform these operations by himself or herself. The POS terminal 5 may be a semi-self-service POS terminal in a system including a registration device for the salesclerk to perform an operation related to the commodity registration and a payment device for the customer to perform an operation related to the payment processing.

The POS terminal 5 calculates the number of privilege stickers and the points that are to be granted to the customer in a transaction. The POS terminal 5 transmits transaction data including the calculated number of privilege stickers and calculated points to the server device 4. The server device 4 manages the number of privilege stickers and the points included in the received transaction data for each customer. In some examples, the number of privilege stickers and the points may be calculated by the server device 4 based on the transaction data.

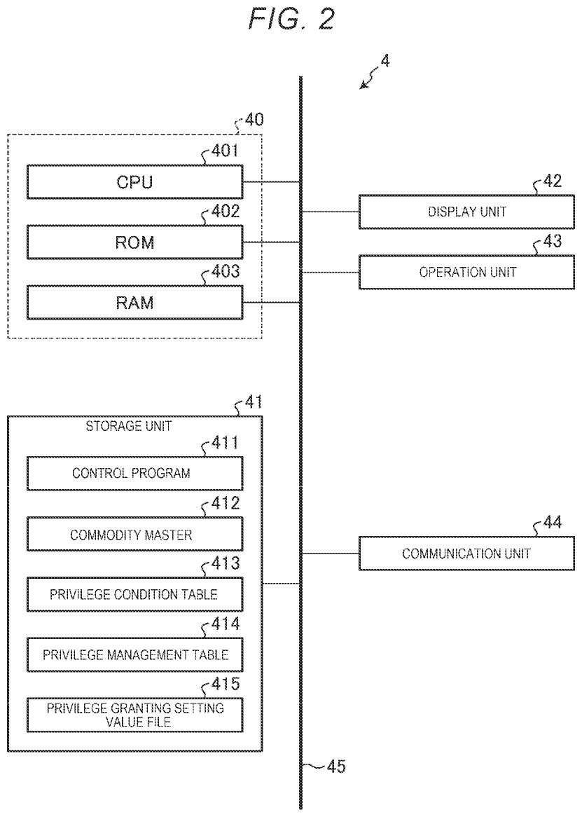

FIG. 2 is a block diagram of the server device 4. The server device 4 includes a control unit 40, a storage unit 41, a display unit 42, an operation unit 43, and a communication unit 44. The control unit 40, the storage unit 41, the display unit 42, the operation unit 43, and the communication unit 44 are connected to one another via a bus 45 or the like.

The control unit 40 has a central processing unit (CPU) 401, a read only memory (ROM) 402, and a random access memory (RAM) 403. The CPU 401, the ROM 402, and the RAM 403 are connected to one another via the bus 45.

The CPU 401 controls each unit of the server device 4. The ROM 402 stores various programs such as programs used for driving the CPU 401 and various data. The RAM 403 is used as a work area of the CPU 401, and loads various programs and various data that are stored in the ROM 402 and the storage unit 41. The control unit 40 executes various control processing of the server device 4 by the CPU 401 operating according to a control program stored in the ROM 402 or the storage unit 41 and loaded in the RAM 403.

The storage unit 41 is implemented as a storage medium such as a hard disk drive (HDD) or a flash memory, and maintains stored contents even when a power supply is turned off. The storage unit 41 stores a control program 411, a commodity master 412, a privilege condition table 413, a privilege management table 414, and a privilege granting setting value file 415.

The control program 411 is a software program or the like for managing (tracking) the number of privilege stickers and points received from the POS terminal 5, a function of setting a specified commodity purchasable at a discount price, a function of setting a service target commodity, a function of providing various types of information to the customer terminal 2 in response to a request from the customer terminal 2, and the like.

The commodity master 412 is a master file in which information (commodity information) related to commodities sold in the store is stored. FIG. 3 is a diagram illustrating a data configuration of the commodity master 412. The commodity master 412 stores a commodity name, a price, a specified commodity flag, and a privilege granting flag in association with a commodity code. Since the commodities sold in the store change day by day, the commodity master 412 is appropriately updated and transmitted to each POS terminal 5.

The commodity code is information for identifying a commodity. The specified commodity flag is information indicating whether a customer can purchase a commodity at a discount price using privilege stickers. The specified commodity flag is registered to be “1” when the commodity is a specified commodity, and is registered to be “0” when the commodity is not a specified commodity. The privilege granting flag is information indicating whether a commodity is a target commodity (service target commodity) to which a privilege sticker is granted. The privilege granting flag is registered to be “1” when the commodity is a service target commodity, and is registered to be “0” when the commodity is not a service target commodity. The specified commodity flag and the privilege granting flag can be freely set by the store according to the privilege service planned by the store.

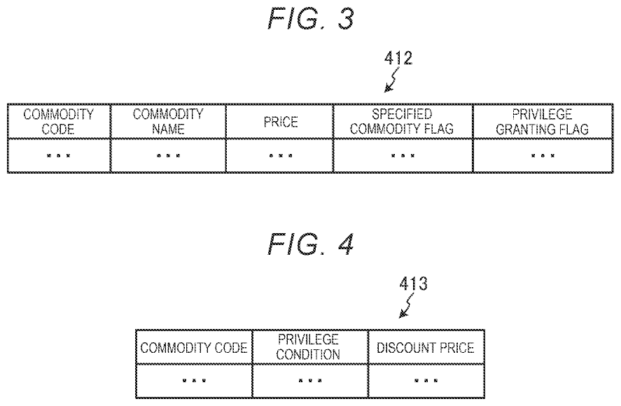

The privilege condition table 413 is a data table for managing information related to the specified commodity. FIG. 4 is a diagram illustrating a data configuration of the privilege condition table 413. The privilege condition table 413 stores a privilege condition and a discount price in association with a commodity code.

The privilege condition is information indicating a condition under which the specified commodity can be purchased at a discount price. As the privilege condition, the number of privilege stickers is registered. The discount price is a special price at which the specified commodity can be purchased when the privilege condition is satisfied. The privilege condition and the discount price can be freely set by the store according to the privilege service planned by the store.

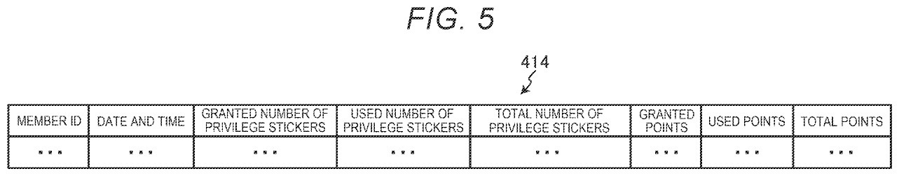

The privilege management table 414 is a data table for managing the number of privilege stickers and points for each customer. FIG. 5 is a diagram illustrating a data configuration of the privilege management table 414. The privilege management table 414 stores a date and time, the granted number of privilege stickers, the used number of privilege stickers, the total number of privilege stickers, granted points, used points, and total points in association with a member ID. The privilege management table 414 is updated according to the transaction data received from the POS terminal 5.

The member ID is information for identifying a member who is qualified for the privilege service. The member ID nay be, for example, a membership number. The date and time is information indicating a date and time when a privilege sticker or a point in management was changed. The granted number of privilege stickers is the number of privilege stickers that has previously granted for purchasing a service target commodity. The used number of privilege stickers is the number of privilege stickers that have been used for purchasing the specified commodity at a discount price. The total (net) number of privilege stickers is the number of privilege stickers held by the customer at a time point indicated by the date and time. The total number of privilege stickers is an example of privilege information that indicates a privilege that can be used for purchasing a specified commodity. The granted points are the number points granted for previous transactions. The used points are the number of points used in a previous transaction. The total (net) points are points held by a customer at a time point indicated by the date and time.

The privilege granting setting value file 415 is a file in which a purchase amount of the service target commodity is set for the grant of one privilege sticker. Specifically, the privilege granting setting value file 415 stores the purchase amount of the service target commodity as a condition for granting one privilege sticker to the customer. The number of privilege stickers to be granted to the customer is calculated based on the total purchase amount of the service target commodity and the amount stored in the privilege granting setting value file 415.

Referring back to FIG. 2, the hardware configuration of the server device 4 will be described. The display unit 42 is a display device and is implemented as a liquid crystal display or the like. The display unit 42 displays various types of information under control of the control unit 40. For example, the display unit 42 displays an input screen or the like for inputting information into the commodity master 412, the privilege condition table 413, the privilege granting setting value file 415, and the like.

The operation unit 43 is an input device, and can be a touch panel provided on a surface of the display unit 42, a mouse, and the like. Information input via the operation unit 43 by operations of the salesclerk or the like is input into the control unit 40.

The communication unit 44 is an interface for communicating with external devices such as the customer terminal 2 and the POS terminal 5. The control unit 40 can transmit and receive information (data) to and from the external devices by being connected to the external devices via the communication unit 44.

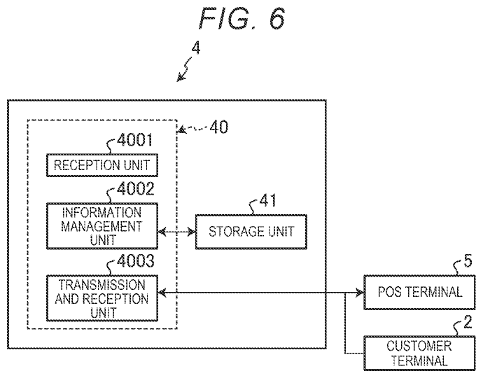

Next, functional aspects of the control unit 40 of the server device 4 will be described. FIG. 6 is a block diagram of the control unit 40 of the server device 4. The control unit 40 functions as a reception unit 4001, an information management unit 4002, and a transmission and reception unit 4003 when the CPU 401 operates according to the control program stored in the ROM 402 or the storage unit 41. In some examples, described functions of these units may be implemented by hardware such as a dedicated circuit.

The reception unit 4001 receives various types of information from the customer terminal 2 or the POS terminal 5 via the transmission and reception unit 4003. For example, the reception unit 4001 receives an inquiry about held information on the number of privilege stickers or points from the customer terminal 2. The reception unit 4001 receives the transaction data from the POS terminal 5. Further, the reception unit 4001 receives various types of operation information input via the operation unit 43.

The information management unit 4002 manages various types of information received by the reception unit 4001. For example, in response to the inquiry received by the reception unit 4001, the information management unit 4002 reads the total number of privilege stickers and the total points from the privilege management table 414. The information management unit 4002 updates the privilege management table 414 according to newly granted number of privilege stickers, newly granted points, and the like included in the transaction data received from the POS terminal 5. Further, the information management unit 4002 updates the commodity master 412, the privilege condition table 413, the privilege granting setting value file 415, and the like according to the operation information received by the reception unit 4001.

The transmission and reception unit 4003 transmits and receives various types of information to and from the customer terminal 2 and the POS terminal 5. For example, the transmission and reception unit 4003 receives an inquiry about the held information on the number of privilege stickers or points from the customer terminal 2, and transmits, in response to the inquiry, the number of privilege stickers and the points held by the customer to the customer terminal 2. In addition, the transmission and reception unit 4003 receives the member ID from the POS terminal 5, and transmits, to the POS terminal 5, the number of privilege stickers and the points held by a customer identified by the member ID. Further, the transmission and reception unit 4003 transmits, to each POS terminal 5, the updated commodity master 412, privilege condition table 413, and privilege granting setting value file 415.

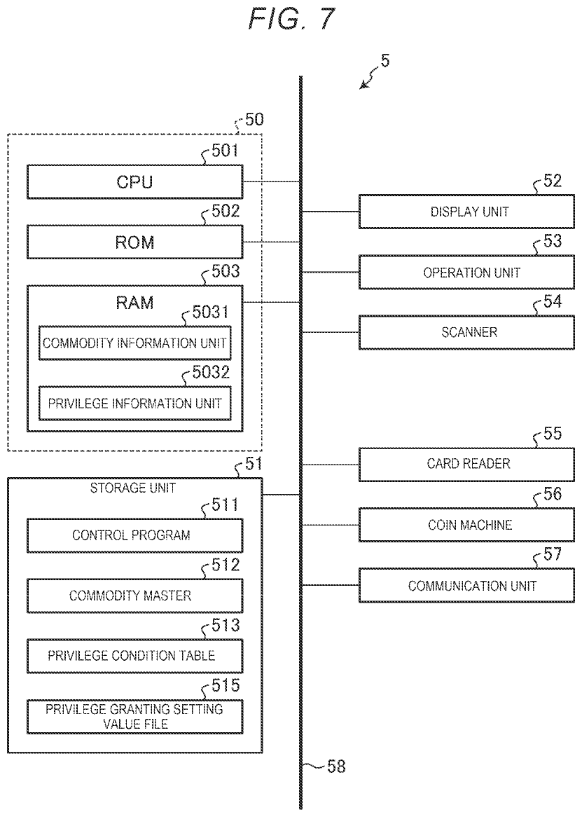

FIG. 7 is a block diagram illustrating a hardware configuration of the POS terminal 5. The POS terminal 5 includes a control unit 50, a storage unit 51, a display unit 52, an operation unit 53, a scanner 54, a card reader 55, a coin machine 56, and a communication unit 57. The control unit 50, the storage unit 51, the display unit 52, the operation unit 53, the scanner 54, the card reader 55, the coin machine 56, and the communication unit 57 are connected to one another via a bus 58 or the like.

The control unit 50 includes a CPU 501, a ROM 502, and a RAM 503. The CPU 501, the ROM 502, and the RAM 503 are connected to one another via the bus 58.

The CPU 501 controls operations of the entire POS terminal 5. The ROM 502 stores various programs such as programs used for driving the CPU 501 and various data. The RAM 503 is used as a work area of the CPU 501, and loads various programs and various data that are stored in the ROM 502 and the storage unit 51. The control unit 50 executes various control processing of the POS terminal 5 by the CPU 501 operating according to a control program stored in the ROM 502 or the storage unit 51 and loaded in the RAM 503.

The RAM 503 includes a commodity information unit 5031 and a privilege information unit 5032. The commodity information unit 5031 stores commodity information (commodity code, commodity name, price, and the like) of a commodity identified by a commodity code read by the scanner 54. Commodity registration is executed by registering (storing) the commodity information in the commodity information unit 5031. The privilege information unit 5032 stores the number of privilege stickers and points held by a customer identified by a member ID read by the scanner 54 or the card reader 55. In the following description, the number of privilege stickers and/or points held by the customer may be referred to as privilege information.

The storage unit 51 is implemented as a storage medium such as a HDD or a flash memory and maintains stored contents even when the power supply is turned off. The storage unit 51 stores a control program 511, a commodity master 512, a privilege condition table 513, and a privilege granting setting value file 515.

The control program 511 is a software program or the like for implementing a function of performing commodity registration and payment processing based on a commodity code read by the scanner 54, a function of transmitting and receiving various types of information to and from the server device 4, a function of acquiring the privilege information based on the member ID read by the scanner 54 or the card reader 55, a function of changing the privilege information according to a transaction, and the like.

The commodity master 512, the privilege condition table 513, and the privilege granting setting value file 515 (also collectively referred to as “reception files”) are received from the server device 4. The POS terminal 5 receives the reception files from the server device 4 and updates the reception files at a predetermined time, for example, before the store opens every day. Since data configurations of the reception files are the same as those stored in the server device 4, redundant descriptions thereof will be omitted. The storage unit 51 may be configured not to store the reception files. In this case, the POS terminal 5 communicates with the server device 4 and refers to the commodity master 412, the privilege condition table 413, and the privilege granting setting value file 415 that are stored in the server device 4, so that the POS terminal 5 can exhibit the same function as a configuration of storing the reception files.

The display unit 52 is a display device and is implemented as a liquid crystal display or the like. The display unit 52 displays various types of information under control of the control unit 50. For example, the display unit 52 displays commodity information of a registered commodity, a total amount (transaction amount) of one transaction, and the like. In addition, the display unit 52 displays the number of privilege stickers, points, and the like to be granted to the customer in one transaction.

The operation unit 53 is an input device and includes a touch panel provided on a surface of the display unit 52, a keyboard provided separately from the display unit 52, and the like. Various types of information input via the operation unit 53 by operations of the salesclerk or the like is input into the control unit 50. For example, the operation unit 53 inputs, into the control unit 50, a privilege use instruction for declaring that the customer purchases the specified commodity using the privilege stickers.

The scanner 54 reads a commodity code from a code symbol (also referred to as a “commodity barcode”) such as a barcode attached to a commodity. Specifically, the scanner 54 recognizes the commodity barcode in an optical manner or by capturing an image of the commodity barcode. Then, the scanner 54 decodes the recognized commodity barcode and reads the commodity code indicated by the commodity barcode. The commodity barcode recognized by the scanner 54 may be decoded by the control unit 50. The scanner 54 reads a member code from the barcode displayed on the customer terminal 2. The scanner 54 may be fixedly provided in the POS terminal 5, or may be a hand-held scanner that can be operated by the salesclerk with a hand.

The card reader 55 reads a member ID from a membership card of a customer. In addition, the card reader 55 reads customer information necessary for credit card settlement from a credit card of the customer. The card reader 55 may be a magnetic card reader that reads information from a magnetic card, or may be an IC card reader that reads information from a card provided with a built-in IC chip.

When the customer pays a purchase price in cash, the coin machine 56 receives bills and coins paid by the customer and dispenses coins as necessary.

The communication unit 57 is an interface for communicating with an external device such as the server device 4. The control unit 50 can transmit and receive information (data) to and from the external device by being connected to the external device via the communication unit 57.

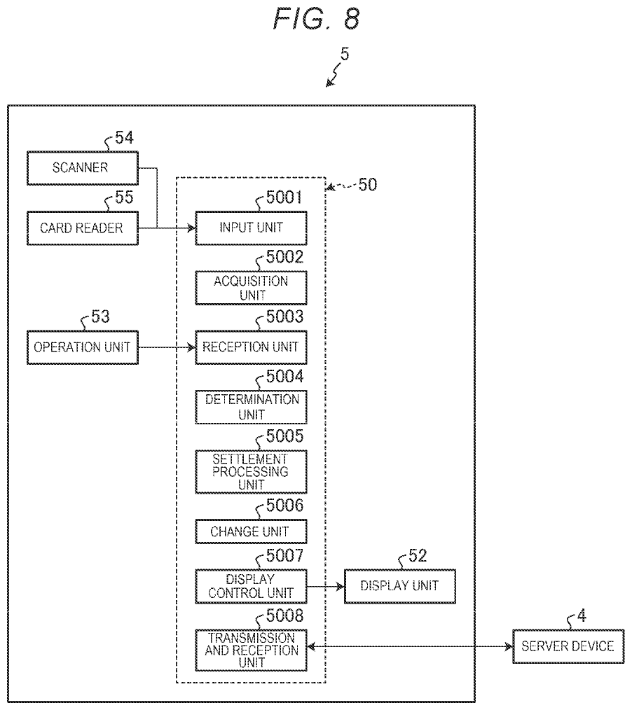

Next, functional aspects of the control unit 50 of the POS terminal 5 will be described. FIG. 8 is a block diagram of the control unit 50 of the POS terminal 5. The control unit functions as an input unit 5001, an acquisition unit 5002, a reception unit 5003, a determination unit 5004, a settlement processing unit 5005, a change unit 5006, a display control unit 5007, and a transmission and reception unit 5008 by the CPU 501 operating according to a control program stored in the ROM 502 or the storage unit 51. In some examples, these described functions may be implemented by using hardware such as a dedicated circuit.

Various types of information are input into the input unit 5001 from the scanner 54 and the card reader 55. For example, a member ID can be input into the input unit 5001 from the scanner 54 or the card reader 55. The input unit 5001 functions as a first input unit into which customer identification information for identifying a customer is input. The commodity code can be input into the input unit 5001 from the scanner 54. In such a case, the input unit 5001 functions as a second input unit into which commodity information for identifying a commodity is input.

The acquisition unit 5002 acquires privilege information for a customer corresponding to the customer identification information input into the first input unit. Specifically, the acquisition unit 5002 acquires the total number of privilege stickers received by the transmission and reception unit 5008 from the server device 4. The total number of privilege stickers acquired by the acquisition unit 5002 is the total number of privilege stickers corresponding to the member ID input into the input unit 5001.

The reception unit 5003 receives a privilege use instruction for declaring an intention that a specified commodity is to be purchased using a privilege. Specifically, the reception unit 5003 receives the privilege use instruction input via the operation unit 53. The privilege use instruction is information input via the operation unit 53 by the salesclerk when the customer wants to purchase the specified commodity at a discount price using the privilege stickers.

The determination unit 5004 determines whether the commodity identified by the commodity code input into the input unit 5001 is a specified commodity. Specifically, the determination unit 5004 refers to the commodity master 512 and reads a specified commodity flag corresponding to the commodity code. The determination unit 5004 determines that a commodity is a specified commodity when “1” is registered in the specified commodity flag, and determines that a commodity is not a specified commodity when “0” is registered in the specified commodity flag.

In addition, the determination unit 5004 determines whether the privilege information acquired by the acquisition unit 5002 satisfies a privilege condition set in advance for each specified commodity. Specifically, the determination unit 5004 reads the number of privilege stickers required for the specified commodity to be purchased by the customer at a discount from the privilege condition table 513. Then, the determination unit 5004 determines whether the total number of privilege stickers held by the customer is equal to or greater than the number of privilege stickers required for the specified commodity to be purchased as a discount (as read from the privilege condition table 513).

When the total number of privilege stickers held by the customer is equal to or greater than the required number of privilege stickers read from the privilege condition table 513, the determination unit 5004 determines that the privilege condition is satisfied. When the total number of privilege stickers held by the customer is less than the required number of privilege stickers read from the privilege condition table 513, the determination unit 5004 determines that the privilege condition is not satisfied. In some examples, POS terminal 5 need not include the determination unit 5004. In this case, a function of the determination unit 5004 is included in the server device 4 and POS terminal 5 acquires a determination result from the server device 4.

The settlement processing unit 5005 executes settlement processing related to a transaction. The settlement processing is processing for a customer to complete payment of a purchase price. When the commodity identified by the commodity identification information input into the input unit 5001 is a specified commodity and the privilege indicated by the privilege information acquired by the acquisition unit 5002 satisfies the condition under which the privilege can be used for purchasing the specified commodity, the settlement processing unit 5005 performs the settlement processing on the specified commodity at a discount price assuming the reception unit 5003 received the privilege use instruction.

Specifically, the settlement processing unit 5005 performs the settlement processing on the specified commodity at a discount price under conditions that the commodity identified by the commodity code input into the input unit 5001 is a specified commodity, the number of privilege stickers held by the customer and acquired by the acquisition unit 5002 is equal to or greater than the number of privilege stickers set as the privilege condition of the specified commodity, and the reception unit 5003 receives the privilege use instruction. For example, the settlement processing unit 5005 calculates the transaction amount of a transaction by setting the price of the specified commodity as the discount price.

The change unit 5006 changes the privilege information previously acquired by the acquisition unit 5002 based on the privilege(s) used for purchasing the specified commodity in the transaction. Specifically, when the customer purchases the specified commodity using privilege stickers, the change unit 5006 changes the number of privilege stickers held by the customer in the privilege information unit 5032. More specifically, when the customer purchases the specified commodity using the privilege stickers, the change unit 5006 subtracts the number of privilege stickers used for purchasing the specified commodity from the held number of privilege stickers stored in the privilege information unit 5032.

The change unit 5006 may also change the number of privilege stickers stored in the privilege information unit 5032 as necessary in other scenarios. For example, when the customer purchases a service target commodity and is thus to be granted a privilege sticker, the change unit 5006 adds the newly granted privilege sticker(s) to the total granted number of privilege stickers stored in the privilege information unit 5032.

The change unit 5006 can also change the number of privilege stickers separately from the payment processing. As an example of changing the number of privilege stickers separately from the payment processing, there are cases including a case of performing processing related to return of a commodity, a case of granting a number of privilege stickers related to a previous transaction for which the customer did not carry the membership card at the time of the earlier transaction, and the like. In this context, payment processing is processing executed by the POS terminal 5 in order for a customer to pay for a purchased commodity, and includes processing related to commodity registration, settlement processing, and receipt issuance.

The display control unit 5007 causes the display unit 52 to display various types of information. For example, the display control unit 5007 causes the display unit 52 to display a privilege use instruction screen. The privilege use instruction screen is a screen for inputting whether to purchase a specified commodity using privilege stickers after the scanner 54 reads the commodity code of a specified commodity during commodity registration. In addition, the display control unit 5007 causes the display unit 52 to display a screen indicating the purchase amount of the service target commodity and the granted number of privilege stickers for the transaction at the time of settlement of the transaction. Further, when the number of privilege stickers is to be changed separately from the payment processing, the display control unit 5007 causes the display unit 52 to display a screen for inputting the number of privilege stickers to be changed.

The transmission and reception unit 5008 transmits and receives various types of information to and from the server device 4. For example, when the member ID is input into the input unit 5001, the transmission and reception unit 5008 transmits a privilege information request of the member identified by the member ID to the server device 4. Then, the transmission and reception unit 5008 receives the privilege information from the server device 4 as a response to the privilege information request. In addition, the transmission and reception unit 5008 receives reception files from the server device 4.

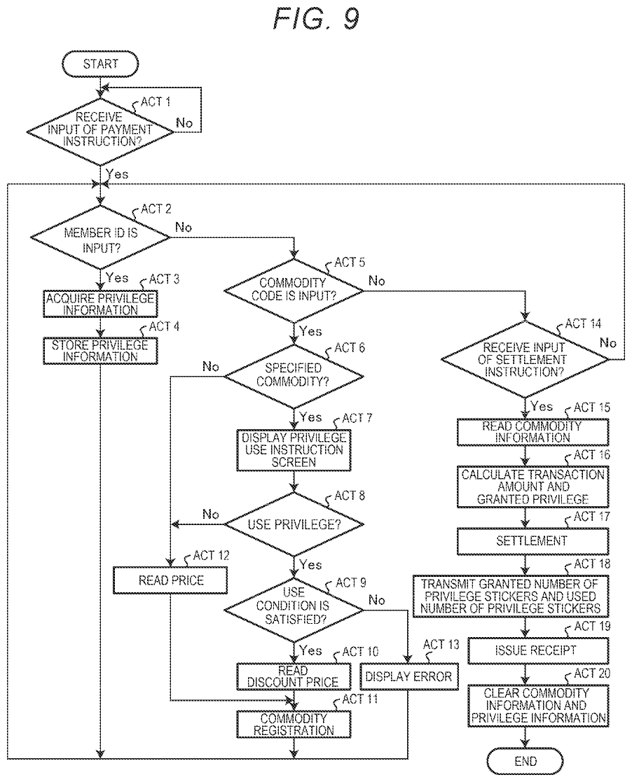

Next, the payment processing executed by the POS terminal 5 will be described. FIG. 9 is a flowchart illustrating a flow of the payment processing executed by the control unit 50 of the POS terminal 5. The payment processing is executed when the customer pays for the purchased commodity.

The control unit 50 determines whether the reception unit 5003 has received an input of a payment instruction from the operation unit 53 (ACT 1). If not (No in ACT 1), the control unit 50 returns to the processing of ACT 1 and waits. When the reception unit 5003 receives the input of the payment instruction from the operation unit 53 (Yes in ACT 1), the control unit 50 determines whether a member ID is input into the input unit 5001 (ACT 2).

When the member ID is input into the input unit 5001 (Yes in ACT 2), the acquisition unit 5002 acquires privilege information corresponding to the member ID from the server device 4 (ACT 3). The privilege information acquired by the acquisition unit 5002 includes the number of privilege stickers held by the member identified by the member ID. Subsequently, the control unit 50 stores the privilege information acquired by the acquisition unit 5002 in the privilege information unit 5032 (ACT 4), and returns to the processing of ACT 2.

In the processing of ACT 2, when a member ID is not input into the input unit 5001 (No in ACT 2), the control unit determines whether a commodity code has been input into the input unit 5001 (ACT 5). If the commodity code is input into the input unit 5001 (Yes in ACT 5), the determination unit 5004 refers to the commodity master 512 and determines whether the commodity identified by the commodity code is a specified commodity (ACT 6).

When the commodity identified by the commodity code is a specified commodity (Yes in ACT 6), the display control unit 5007 causes the display unit 52 to display the privilege use instruction screen (ACT 7). The privilege use instruction screen is a screen that displays an operating element for inputting an instruction to use a privilege sticker after the commodity identified by the commodity code input into the input unit 5001 is determined to be a specified commodity.

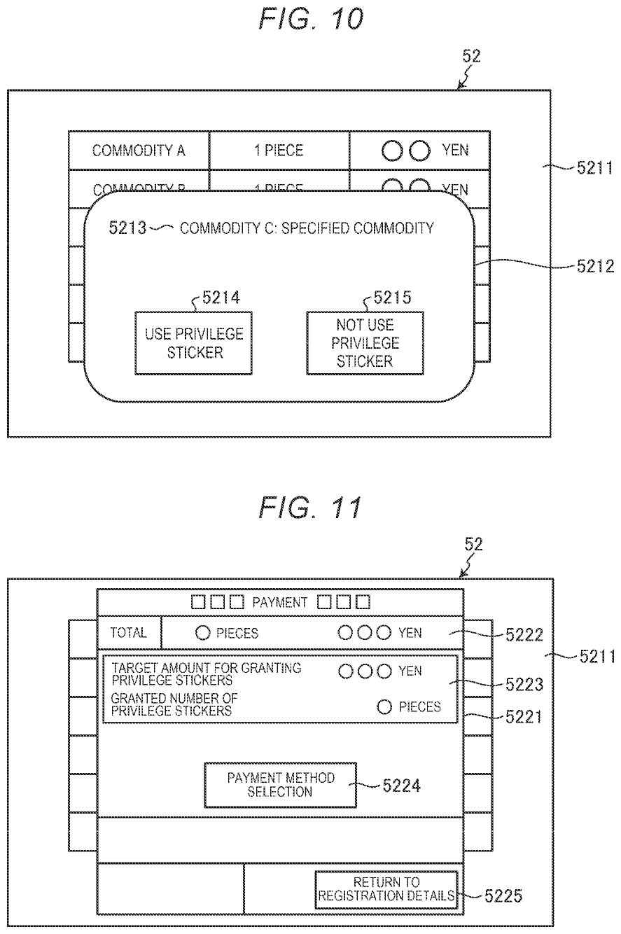

FIG. 10 is a diagram illustrating the privilege use instruction screen. The privilege use instruction screen is a screen formed by displaying a privilege use instruction display portion 5212 in a pop-up manner while a commodity information display portion 5211 is being displayed. Commodity information corresponding to the commodity code input into the input unit 5001 is displayed on the commodity information display portion 5211. Examples of the displayed commodity information include a commodity name, the number of a corresponding commodity, and a price. The commodity information is displayed on the commodity information display portion 5211 in an order in which the commodity code is input into the input unit 5001, in other words, in an order in which each commodity was registered.

When the commodity code of a specified commodity is input into the input unit 5001, the display unit 52 displays the privilege use instruction display portion 5212 in a pop-up manner on the commodity information display portion 5211. A specified commodity display portion 5213, a use button 5214, and a non-use button 5215 are displayed on the privilege use instruction display portion 5212.

A commodity name and the like along with information indicating that the just registered commodity is a specified commodity are displayed on the specified commodity display portion 5213. Therefore, an operator (a salesclerk in the present embodiment) of the POS terminal 5 can recognize that the commodity just scanned by the scanner 54 is a specified commodity for which the privilege stickers can be used. Accordingly, the salesclerk can confirm with the customer whether to use the accumulated privilege stickers for the purchase of the commodity.

The use button 5214 is a button operated when the customer wants to purchase the specified commodity at a discount price using privilege stickers and is an example of an operating element for inputting a privilege use instruction. When the use button 5214 is operated, information indicating that the privilege stickers are to be used is input into the control unit 50. The non-use button 5215 is a button operated when a customer does not want to use privilege stickers for the purchase of the commodity. When the non-use button 5215 is operated, information indicating that the privilege stickers are not to be used for purchasing the commodity is input into the control unit 50.

By displaying the privilege use instruction screen, even if the customer does not notice that the commodity to be purchased is a specified commodity, the salesclerk can check with the customer whether to use the privilege stickers. Therefore, customer service can be improved. In addition, when the customer uses the privilege stickers, the commodity can be registered at a discount price only by operating the use button 5214, and thus operability can be improved.

Returning to FIG. 9, the payment processing will be described. The control unit 50 determines whether the use button 5214 (see FIG. 10) has been operated, thereby determining whether the reception unit 5003 receives an instruction to use the privilege stickers (ACT 8). When the reception unit 5003 receives the instruction to use the privilege stickers (Yes in ACT 8), the determination unit 5004 next determines whether a use condition is satisfied (ACT 9). Specifically, the determination unit 5004 reads the number of privilege stickers required for the corresponding specified commodity (the privilege condition) from the privilege condition table 513. Then, the determination unit 5004 determines whether the available number of privilege stickers stored in the privilege information unit 5032 is equal to or greater than the required number of privilege stickers. If a member ID has not been input into the input unit 5001, the available number of privilege stickers is not stored in the privilege information unit 5032, and thus it is necessarily determined that the use condition is not satisfied in the processing of ACT 9.

When the use condition is satisfied (Yes in ACT 9), the control unit 50 reads the corresponding discount price from the privilege condition table 513 (ACT 10). In other words, when the available number of privilege stickers stored in the privilege information unit 5032 is equal to or greater than the required number of privilege stickers read from the privilege condition table 513, the control unit 50 reads the discount price. Subsequently, the control unit 50 executes commodity registration (ACT 11) and returns to the processing of ACT 2. In this case, the commodity registration is executed using the discount price rather than the standard (normal) price. In addition, the available number of privilege stickers stored in the privilege information unit 5032 is updated by subtracting the number of privilege stickers used for purchasing the specified commodity.

When the commodity identified by the input commodity code is not a specified commodity in the processing of ACT 6 (No in ACT 6), the control unit 50 simply reads the corresponding price from the commodity master 512 (ACT 12) and proceeds to the processing of ACT 11. In this case, the commodity registration is executed using a normal price rather than the discount price. In the processing of ACT 8, when the privilege stickers are not to be used (No in ACT 8), the control unit 50 proceeds to the processing of ACT 12.

In the processing of ACT 9, when the use condition is not satisfied (No in ACT 9), the display control unit 5007 causes the display unit 52 to display error information (ACT 13). For example, the display control unit 5007 causes the display unit 52 to display a message indicating that the condition for purchasing a commodity at a discount price is not satisfied. Then, the control unit 50 returns to the processing of ACT 2.

If a commodity code is not input in the processing of ACT 5 (No in ACT 5), the control unit 50 next determines whether the reception unit 5003 receives the input of a settlement instruction (ACT 14). When the reception unit 5003 does not receive the input of the settlement instruction (No in ACT 14), the control unit 50 returns to the processing of ACT 2. When the reception unit 5003 receives the input of the settlement instruction (Yes in ACT 14), the settlement processing unit 5005 reads the commodity information stored in the commodity information unit 5031 (ACT 15) and calculates the transaction amount and the granted privileges (the number of privilege stickers and the points) (ACT 16). Subsequently, the settlement processing unit 5005 executes settlement (ACT 17). When the customer pays the purchase price in cash, the settlement processing unit 5005 controls the coin machine 56 to pay out coins and the like. When the customer pays the purchase price with a credit card, the settlement processing unit 5005 communicates with a settlement server managed by a settlement service provider or the like to transmit and receive necessary information for credit card settlement. The settlement processing unit 5005 can performs processing necessary for payment when the customer pays the purchase price by another settlement method such as by two-dimensional code (code-based settlement). When the customer uses accumulated points for settlement, the settlement can be performed after an amount equivalent to points to be used is subtracted from the calculated transaction amount.

A screen displayed by the display unit 52 at the time of settlement will now be described. FIG. 11 is a diagram illustrating a display screen at the time of settlement. When the reception unit 5003 receives the input of a settlement instruction, the display unit 52 displays a settlement information display portion 5221 in a pop-up manner on the commodity information display portion 5211. The commodity information display portion 5211 is the same as in the privilege use instruction screen illustrated in FIG. 10. A total information display portion 5222, a privilege information display portion 5223, a payment method selection button 5224, and a return button 5225 are displayed on the settlement information display portion 5221.

The total number of the commodities after commodity registration and a total amount (transaction amount) for the commodities are displayed on the total information display portion 5222. A target amount for granting privilege stickers and the granted number of privilege stickers in the transaction are displayed on the privilege information display portion 5223. The target amount for granting privilege stickers indicates a purchase amount of the service target commodity among the transaction amount. The granted number of privilege stickers is the number of privilege stickers granted according to the target amount for granting privilege stickers.

The payment method selection button 5224 is an operation button for shifting to a screen for selecting a payment method. The salesclerk confirms the total information display portion 5222, the privilege information display portion 5223, and the like, and operates the payment method selection button 5224 when there is no error. The return button 5225 is an operation button for returning to a registration screen on which the commodity information display portion 5211 is displayed. The salesclerk confirms the total information display portion 5222, the privilege information display portion 5223, and the like, and operates the return button 5225 when it is considered that there is an error in the commodity registration or the like.

Returning to FIG. 9, the payment processing will be described. When the settlement is completed, the transmission and reception unit 5008 transmits, to the server device 4, the granted number of privilege stickers (calculated in ACT 16) and the number of privilege stickers used for purchasing the specified commodity together with the member ID (ACT 18). Next, the control unit 50 controls a printer or the like to issue a receipt (ACT 19). Various types of receipts to be issued are not limited to paper receipts, and electronic receipts or the like may also or instead be issued. Subsequently, the control unit 50 clears the information stored in the commodity information unit 5031 and the privilege information unit 5032 (ACT 20) and ends the payment processing. In other words, when the settlement related to a transaction and the receipt issuance are ended, the control unit 50 clears information related to the transaction and prepares for payment processing of the next transaction.

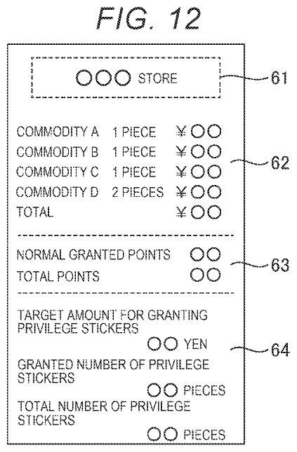

A receipt issued after the settlement will be described. FIG. 12 is a diagram illustrating a receipt issued by the POS terminal 5. A store name 61, commodity information 62, point information 63, and privilege sticker information 64 are printed on the receipt. In the commodity information 62, a commodity name, the number of a purchased commodity, and an amount of money are printed for each commodity purchased by a customer. A total amount (transaction amount) of the transaction is also printed in the commodity information 62. In the point information 63, points granted in a current transaction and total points are printed. In the privilege sticker information 64, the target amount for granting privilege stickers (total amount of purchased service target commodities) and the granted number of privilege stickers in the current transaction are printed. In addition, the total number of privilege stickers after the transaction is also printed in the privilege sticker information 64. For a customer who is not a member or a customer who is a member but forgot to carry the membership card otherwise can not input the member ID at the time of payment processing, the total points and the total number of privilege stickers are not printed.

By the above payment processing, the POS terminal 5 can not only perform settlement and grant a privilege for a transaction, but also manage the number of privilege stickers granted to the customer in cooperation with the server device 4.

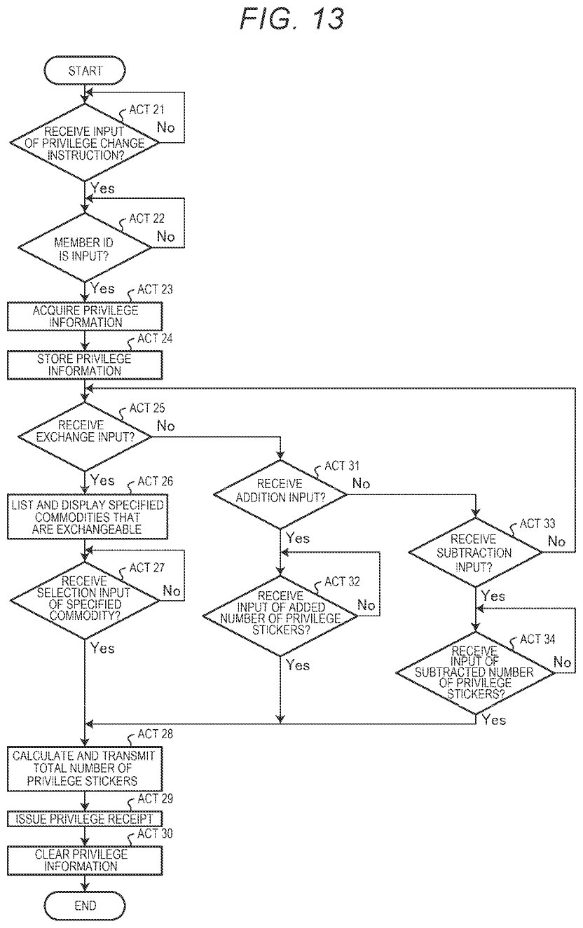

Next, the privilege sticker change processing executed by the POS terminal 5 will be described. FIG. 13 is a flowchart illustrating a flow of the privilege sticker change processing executed by the control unit 50 of the POS terminal 5. The privilege sticker change processing is processing mainly for updating the number of privilege stickers held by the customer. The privilege sticker change processing can be executed, for example, when the customer returns a previously purchased commodity, when the privilege stickers are granted after a transaction has already been completed but the customer forgot to carry the membership card at the time of payment processing for the transaction, or when the customer purchases just a specified commodity using privilege stickers (that is, no other items are being purchased in the transaction).

The control unit 50 determines whether the reception unit 5003 has received input of a privilege change instruction from the operation unit 53 (ACT 21). If not (No in ACT 21), the control unit 50 returns to the processing of ACT 21 and waits. The input of the privilege change instruction is an instruction for changing the number of privilege stickers held by the customer, that is, the number of privilege stickers managed by the server device 4, separately from transaction payment processing. When the reception unit 5003 receives the input of the privilege change instruction from the operation unit 53 (Yes in ACT 21), the control unit 50 determines whether a member ID has been input into the input unit 5001 (ACT 22).

When the member ID has not been input into the input unit 5001 (No in ACT 22), the control unit 50 returns to the processing of ACT 22 and waits. When the member ID is input into the input unit 5001 (Yes in ACT 22), the acquisition unit 5002 next acquires the available number of privilege stickers (privilege information) corresponding to the member ID from the server device 4 (ACT 23). Subsequently, the control unit 50 stores the privilege information acquired by the acquisition unit 5002 in the privilege information unit 5032 (ACT 24).

Next, the control unit 50 determines whether the reception unit 5003 receives exchange input from the operation unit 53 (ACT 25). The exchange input is information indicating that the customer purchased the specified commodity at a discount price using the privilege stickers (also referred to as an “exchange” or a “return”).

When the reception unit 5003 receives the exchange input from the operation unit 53 (Yes in ACT 25), the display control unit 5007 causes the display unit 52 to display a list of specified commodities that are exchangeable. Specifically, the display control unit 5007 refers to the privilege condition table 513, extracts commodities in which the number of privilege stickers stored in the privilege condition is equal to or less than the number of privilege stickers acquired from the server device 4, that is, exchangeable commodities, and lists the extracted exchangeable commodities and causes the display unit 52 to display these commodities in a selectable manner (ACT 26).

Subsequently, the control unit 50 determines whether the reception unit 5003 receives selection input of a specified commodity from the operation unit 53 (ACT 27). If not (No in ACT 27), the control unit 50 returns to the processing of ACT 27 and waits. The salesclerk can select the specified commodity from the list of exchangeable commodities displayed on the display unit 52. When the reception unit 5003 receives the selection input of the specified commodity (Yes in ACT 27), the control unit 50 calculates the total number of privilege stickers and transmits the total number of privilege stickers and the member ID to the server device 4 (ACT 28). When the specified commodity is exchanged, the total number of privilege stickers is calculated by subtracting the number of privilege stickers used in the exchange from the used number of privilege stickers stored in the privilege information unit 5032.

Next, the control unit 50 controls a printer or the like to issue a privilege receipt (ACT 29), clears the information stored in the privilege information unit 5032 (ACT 30), and ends the privilege sticker change processing. The privilege receipt to be issued will be described later.

When the exchange input is performed to purchase a specified commodity rather than return a previously purchased commodity, that is, when the customer purchases the specified commodity using the privilege stickers, the settlement processing can be performed at a discount price following the processing of ACT 30. In the present embodiment, since the specified commodity to be purchased is selected in the privilege sticker change processing, the settlement processing for the specified commodity can be performed as a part of the privilege sticker change processing.

In the processing of ACT 25, if the reception unit 5003 does not receive the exchange input (No in ACT 25), the control unit 50 next determines whether the reception unit 5003 receives an addition input (ACT 31). The addition input is information that is input when processing for adding to the granted number of privilege stickers stored in the server device 4 is performed separately from the payment processing (outside a commodity purchase transaction). The addition input is input, for example, when the privilege stickers are granted later to the customer who forgot a membership card at the time of a previous transaction payment processing.

Next, the control unit 50 determines whether the reception unit 5003 receives input of the added number of privilege stickers from the operation unit 53 (ACT 32). If not (No in ACT 32), the control unit 50 returns to the processing of ACT 32 and waits. When the reception unit 5003 receives the input of the added number of privilege stickers from the operation unit 53 (Yes in ACT 32), the control unit 50 proceeds to the processing of ACT 28. When privilege stickers are added, the total number of privilege stickers is calculated in ACT 28 by adding the input added number of privilege stickers to the granted number of privilege stickers stored in the privilege information unit 5032.

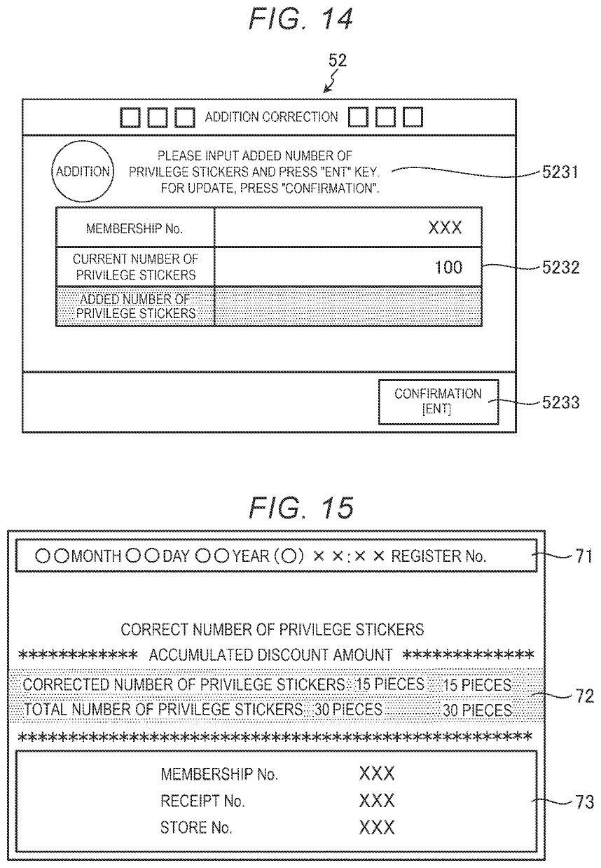

A privilege sticker addition screen for inputting the added number of privilege stickers will be described. FIG. 14 is a diagram illustrating the privilege sticker addition screen. When the reception unit 5003 receives the addition input, the display unit 52 displays the privilege sticker addition screen. A message display portion 5231, an information display portion 5232, and a confirmation button 5233 are displayed on the privilege sticker addition screen.

A message for promoting input of the number of privilege stickers to be added is displayed on the message display portion 5231. A membership number, the current number of privilege stickers, and the added number of privilege stickers are displayed on the information display portion 5232. The membership number forms the member ID and is a member ID input into the input unit 5001. The current number of privilege stickers is the total number of privilege stickers corresponding to a member ID. The total number of privilege stickers is acquired from the server device 4 after the member ID is input into the input unit 5001. That is, the current number of privilege stickers is the available number of privilege stickers before being updated in the privilege sticker change processing. The added number of privilege stickers is the number of privilege stickers input into the operation unit 53.

For example, the added number of privilege stickers is input as follows. First, the salesclerk operating the POS terminal 5 takes the receipt issued at the time of payment processing from the customer and confirms the appropriate number of privilege stickers to be granted based on the transaction information on the receipt. Then, the salesclerk inputs the granted number of privilege stickers via the privilege sticker addition screen. By reviewing the receipt to see that a total number of privilege stickers was not printed on the receipt, the salesclerk can recognize privilege stickers were not already granted at the time of the payment processing.

Returning to FIG. 13, the privilege sticker change processing will be further described. When the addition input is not received in ACT 31 (No in ACT 31), the control unit 50 next determines whether the reception unit 5003 receives a subtraction input (ACT 33). The subtraction input is information that is input when processing for subtracting the number of privilege stickers stored in the server device 4 is performed separately from the payment processing of a transaction. The subtraction input is input, for example, when the customer returns a previously purchased commodity and money is refunded to the customer. When the reception unit 5003 does not receive the subtraction input (No in ACT 33), the control unit 50 returns to the processing of ACT 25.

When the reception unit 5003 receives the subtraction input (Yes in ACT 33), the control unit 50 next determines whether the reception unit 5003 receives input of the subtracted number of privilege stickers from the operation unit 53 (ACT 34). If not (No in ACT 34), the control unit 50 returns to the processing of ACT 34 and waits. Once the reception unit 5003 receives the input of the subtracted number of privilege stickers from the operation unit 53 (Yes in ACT 34), the control unit 50 proceeds to the processing of ACT 28. When privilege stickers are to be subtracted, the total number of privilege stickers is calculated in ACT 28 by subtracting the input subtracted number of privilege stickers from the granted number of privilege stickers stored in the privilege information unit 5032.

A privilege sticker subtraction screen for inputting the subtracted number of privilege stickers is similar to the privilege sticker addition screen. Specifically, the privilege sticker subtraction screen is the same as the privilege sticker addition screen except that “addition” in the privilege sticker addition screen illustrated in FIG. 14 is replaced with “subtraction”. Therefore, the salesclerk can input the subtracted number of privilege stickers in the same manner as the input of the added number of privilege stickers.

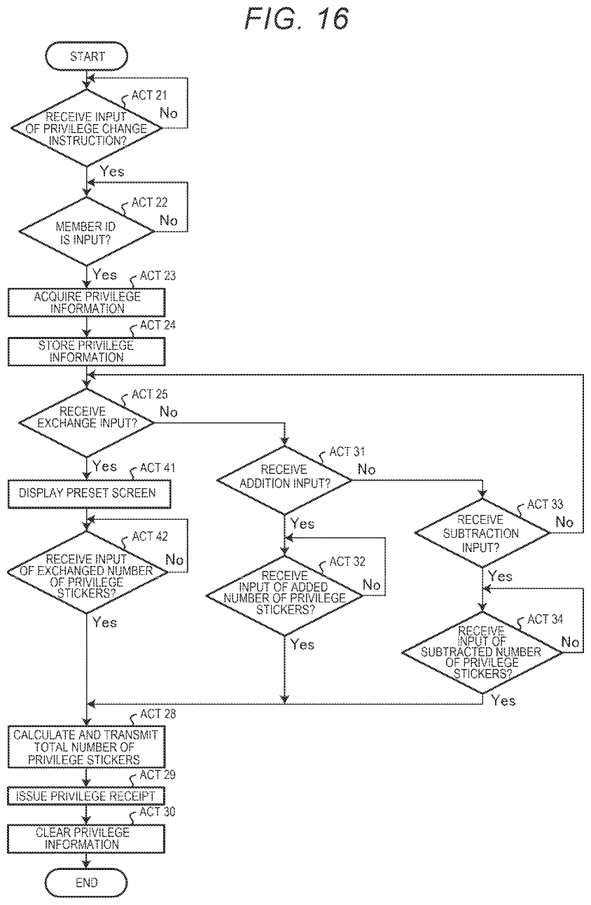

A privilege receipt issued after the number of privilege stickers is calculated based on the exchange input, the addition input, and/or the subtraction input will be described. FIG. 15 is a diagram illustrating a privilege receipt issued by the POS terminal 5. Processing information 71, change information 72, and processing target information 73 are printed on the privilege receipt. In the processing information 71, a date and time when the privilege sticker change processing was executed and a POS terminal number are printed. In the change information 72, the number of corrected (changed) privilege stickers and the total number of privilege stickers are printed. In the processing target information 73, a membership number (ID) of a customer requesting the privilege sticker change processing, a receipt number, and a number of the store at which the privilege sticker change processing was performed are printed.

By the described privilege sticker change processing, even when payment processing is not in progress, the POS terminal can be used to change the number of privilege stickers held by the customer, in other words, the toral number of privilege stickers of the customer, as tracked by the server device 4, when necessary or requested. In addition, when the exchange input is performed, since a list of commodities that are purchasable for the customer using the privilege stickers is displayed, the salesclerk can notify the customer of the purchasable commodities. Therefore, customer service can be improved. The rewards points held by the customer can also be changed by substantially the same processing as the privilege sticker change processing.

As described above, the POS terminal 5 according to the first embodiment includes a first input unit (the input unit 5001) configured to receive customer identification information for identifying a customer; a second input unit (the input unit 5001) configured to receive commodity identification information for identifying a commodity; an acquisition unit 5002 configured to acquire privilege information set in advance indicating a privilege that can be used by the customer to purchase a specified commodity; a reception unit 5003 configured to receive a privilege use instruction for declaring an intention to purchase a specified commodity using the privilege; and a settlement processing unit 5005 configured to perform settlement processing on the specified commodity at a discount price if the reception unit 5003 received the privilege use instruction and the commodity identified by the commodity identification information input into the second input unit is a specified commodity and the privilege indicated by the privilege information acquired by the acquisition unit 5002 meets a condition under which the privilege is usable for purchasing the specified commodity.

Accordingly, the privilege that can be used to purchase the specified commodity can be tracked for each customer. Therefore, the store can more easily implement the privilege service. In addition, when the customer actually uses the privilege to purchase the specified commodity, the information indicating the accumulated privilege(s) held by the customer is also updated according to the settlement processing, and thus it is possible to simplify operations for the operator of the POS terminal 5.

The POS terminal 5 according to the first embodiment further includes the determination unit 5004 configured to determine whether the privilege indicated by the privilege information (acquired by the acquisition unit 5002) satisfies a privilege condition set in advance for the specified commodity.

Accordingly, the operator of the POS terminal 5 does not need to separately determine whether the customer can purchase the specified commodity using the held privilege. In this regard, the operations of the operator can also be simplified.

The POS terminal 5 according to the first embodiment further includes the display control unit 5007 configured to cause the display unit 52 to display an operating element for inputting the privilege use instruction when a commodity identified by the commodity identification information input into the input unit 5001 is the specified commodity (an item to which the privilege can be applied).

Accordingly, when a commodity whose commodity barcode is read in the payment processing is a specified commodity, the operator of the POS terminal 5 can easily recognize that the scanned commodity is a specified commodity. Therefore, customer service can be improved since the operator can notify the customer that a held privilege can be used for the purchase of the scanned commodity. The settlement can be performed at a discount price (according to the privilege of the customer) by operating the displayed operating element, and thus the operations of the operator can be simplified.

In addition, the POS terminal 5 according to the first embodiment further includes the display control unit 5007 which can be configured to cause the display unit 52 to display a selection screen on which the specified commodity is selectable when the reception unit 5003 receives the privilege use instruction.

Accordingly, the operator of the POS terminal 5 can more easily select the specified commodity to be purchased by the customer using the privilege.

### Second Embodiment

The second embodiment is different from the first embodiment in a display screen at the time of exchange input in privilege sticker change processing, settlement of a specified commodity when the exchange input is performed, and the like. In the following description, points different from the first embodiment will be mainly described, and a detailed description of points common to contents already described will generally be omitted.

FIG. 16 is a flowchart illustrating a flow of the privilege sticker change processing in the second embodiment. The processing that is substantially the same as in the first embodiment is denoted by the same reference symbol.

If the reception unit 5003 receives the exchange input (Yes in ACT 25), the display control unit 5007 causes the display unit 52 to display a preset screen (ACT 41). The preset screen is a screen for facilitating input of the number of privilege stickers to be used for purchasing a specified commodity at the discounted price or the like.

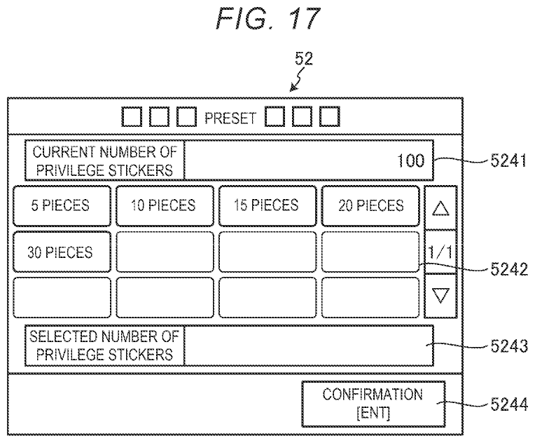

FIG. 17 is a diagram illustrating the preset screen. When the reception unit 5003 receives the exchange input, the display unit 52 displays the preset screen. A held privilege display portion 5241, a preset button display portion 5242, a selected privilege display portion 5243, and a confirmation button 5244 are displayed on the preset screen.

The current number of privilege stickers held by the customer is displayed on the held privilege display portion 5241. The current number of privilege stickers in this context is a total number of privilege stickers corresponding to a member ID. The total number of privilege stickers is acquired from the server device 4 when the member ID is input into the input unit 5001. A plurality of preset buttons are displayed on the preset button display portion 5242. These preset buttons are provided corresponding to the number of privilege stickers to be used in the transaction (exchanged). In the present embodiment, preset buttons are provided for 5, 10, 15, 20, and 30 stickers.

The number of privilege stickers selected by a preset button is displayed on the selected privilege display portion 5243. The number of privilege stickers displayed on the selected privilege display portion 5243 may be based on the selection of more than one of the preset buttons. For example, “20” may be displayed on the selected privilege display portion 5243 after the preset button of “20” is selected, and then “25” may be displayed when the preset button of “5” is next selected before the confirmation button 5244 is operated. The confirmation button 5244 is an operation button for confirming the number of privilege stickers to be used in the transaction. A salesclerk confirms the number of privilege stickers displayed on the selected privilege display portion 5243 and presses the confirmation button 5244. The preset screen may be displayed when an addition input or a subtraction input is received.

Returning to FIG. 16, the privilege sticker exchange processing will be described. After the display control unit 5007 displays the preset screen, the control unit 50 next determines whether the reception unit 5003 receives input of the number (exchanged number) of privilege stickers to be used in the transaction (ACT 42). If no input is received (No in ACT 42), the control unit 50 repeats the processing of ACT 42 and waits. When the reception unit 5003 receives the input for the exchanged number of privilege stickers (Yes in ACT 42), the control unit proceeds to the processing of ACT 28.

In the present embodiment, since no specified commodity to be purchased has been selected at this time, a settlement at a discount price for the specified commodity is not performed following the processing of ACT 30. In the privilege sticker change processing according to the second embodiment, the number of privilege stickers to be used in the purchase transaction is input by the salesclerk instead of being read from the privilege condition table 413. Therefore, it is not necessary to store the privilege condition(s) in advance in the privilege condition table 413 or the like, and the privilege condition(s) can thus be easily changed. For example, it is possible to easily plan different promotions by changing the privilege condition. In addition, since preset buttons corresponding to the privilege condition is displayed, it is possible to prevent a decrease in operability of the salesclerk.

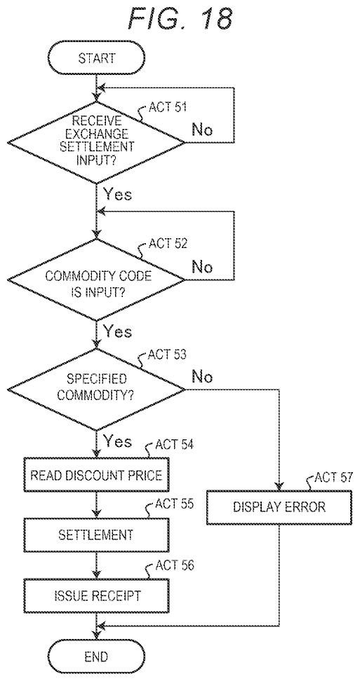

Next, exchange payment processing executed by the POS terminal 5 will be described. FIG. 18 is a flowchart illustrating a flow of the exchange payment processing executed by the control unit 50 of the POS terminal 5. The exchange payment processing is executed separately from the privilege sticker exchange processing when the customer purchases a specified commodity using the privilege stickers.

The control unit 50 determines whether the reception unit 5003 receives exchange settlement input from the operation unit 53 (ACT 51). If not (No in ACT 51), the control unit 50 returns to the processing of ACT 51 and waits. The exchange settlement input declares an intention to purchase a specified commodity using a privilege, and is an example of a privilege use instruction. When the reception unit 5003 receives the exchange settlement input from the operation unit 53 (Yes in ACT 51), the control unit 50 next determines whether a commodity code has been input into the input unit 5001 (ACT 52).

When the commodity code is not yet input into the input unit 5001 (No in ACT 52), the control unit 50 returns to the processing of ACT 52 and waits. When the commodity code is input into the input unit 5001 (Yes in ACT 52), the determination unit 5004 refers to the commodity master 512 and determines whether the commodity identified by the commodity code is a specified commodity (ACT 53).

When the commodity is a specified commodity (Yes in ACT 53), the settlement processing unit 5005 reads a discount price of the commodity from the privilege condition table 413 (ACT 54) and executes settlement based on the discount price (ACT In other words, the settlement processing unit 5005 executes settlement processing in which a price of the commodity identified by the commodity code input into the input unit 5001 is changed to the discount price. The discount price may be input by an operation of the operation unit 53. Next, the control unit 50 controls a printer or the like to issue a receipt (ACT 56). Then, the control unit 50 ends the exchange payment processing.

In the processing of ACT 53, when the commodity identified by the commodity code input into the input unit 5001 is not a specified commodity (No in ACT 53), the display control unit 5007 causes the display unit 52 to display an error message (ACT 57). The error message to be displayed is, for example, a message indicating that the commodity whose commodity barcode has been read is not a specified commodity that can be purchased at a discount price. Then, the control unit 50 ends the exchange payment processing.

As described above, the POS terminal 5 according to the second embodiment includes a first input unit (e.g., input unit 5001) configured to receive customer identification information for identifying a customer; a second input unit (e.g., input unit 5001) configured to receive commodity identification information for identifying a commodity; an acquisition unit 5002 configured to acquire privilege information indicating a privilege that can be used by the customer to purchase a specified commodity; a reception unit 5003 configured to receive a privilege use instruction for declaring an intention to purchase a specified commodity using accumulated privileges; and a settlement processing unit 5005 configured to perform settlement processing in which a price of the commodity identified by the commodity identification information input into the second input unit is changed to a discounted price when the reception unit 5003 receives the privilege use instruction.

Accordingly, the privileges that can be used to purchase a specified commodity can be managed for each customer. Therefore, a store can more easily implement a sticker based privilege service or the like.

The control programs executed by the customer terminal 2, the server device 4, and the POS terminal 5 may be provided by being recorded in a non-transitory, computer-readable recording medium such as a CD-ROM. In addition, these control program may be stored in a computer connected to a network such as the Internet and provided by being downloaded or otherwise accessed via the network.

While certain embodiments have been described, these embodiments have been presented by way of example only, and are not intended to limit the scope of the disclosure. These novel embodiments may be embodied in a variety of other forms; various omissions, substitutions, and changes may be made without departing from the spirit of the disclosure.

What is claimed is:

1. A sales data processing apparatus, comprising:
a communication interface configured to connect to a server; and
a processor configured to:
receive customer identification information for identifying a customer in a sales transaction;
receive commodity identification information for identifying a commodity in the sales transaction;
acquire privilege information from the server indicating a privilege associated with the customer for the purchase of a specified commodity;
receive a privilege use instruction for declaring an intention by the customer to purchase the specified commodity using the privilege; and
register the commodity in the sales transaction at a discounted price if the commodity is the specified commodity, the privilege use instruction declares the intention to purchase the specified commodity using the privilege, and the privilege associated with the customer satisfies a privilege condition set for the specified commodity.

2. The sales data processing apparatus according to claim 1, wherein the processor is further configured to:
determine whether the privilege associated with the customer satisfies the privilege condition for the specified commodity.

3. The sales data processing apparatus according to claim 1, wherein the privilege information indicates whether the privilege associated with the customer satisfies the privilege condition for the specified commodity.

4. The sales data processing apparatus according to claim 1, wherein the processor is further configured to:
cause a display unit to display an operating element for inputting the privilege use instruction when the commodity identified by the commodity identification information is the specified commodity.

5. The sales data processing apparatus according to claim 1, wherein the processor is further configured to:
cause a display unit to display a selection screen with a list of specified commodities from which the specified commodity to which the privilege is to be applied can be selected.

6. The sales data processing apparatus according to claim 1, further comprising:
a barcode reader configured to read a barcode on the commodity and supply the commodity identification information.

7. The sales data processing apparatus according to claim 1, further comprising:
a card reader configured to read a membership card and supply the customer identification information.

8. The sales data processing apparatus according to claim 1, wherein the privilege associated with the customer is based on an accumulated number of privilege stickers from one or more previous sales transactions.

9. A point-of-sale terminal, comprising:
a display screen integrated with a touch panel for receiving operator inputs;
a barcode scanner configured to read barcodes on products and membership cards;
a communication interface configured to connect to a server; and
a processor configured to:
receive customer identification information for identifying a customer in a sales transaction from the barcode scanner;
receive commodity identification information for identifying a commodity in the sales transaction from the barcode scanner;
based on the received customer identification, acquire privilege information from the server indicating a privilege associated with the customer for the purchase of a specified commodity;
receive a privilege use instruction, via the touch panel, for declaring an intention by the customer to purchase the specified commodity using the privilege; and
register the commodity in the sales transaction at a discounted price if the commodity is the specified commodity, the privilege use instruction declares the intention to purchase the specified commodity using the privilege, and the privilege associated with the customer satisfies a privilege condition set for the specified commodity.

10. The point-of-sale terminal according to claim 9, wherein the processor is further configured to:
determine whether the privilege associated with the customer satisfies the privilege condition for the specified commodity.

11. The point-of-sale terminal according to claim 9, wherein the privilege information received from the server indicates whether the privilege associated with the customer satisfies the privilege condition for the specified commodity.

12. The point-of-sale terminal according to claim 9, wherein the processor is further configured to:
cause the display screen to display an operating element for inputting the privilege use instruction when the commodity identified by the commodity identification information is the specified commodity.

13. The point-of-sale terminal according to claim 9, wherein the processor is further configured to:
cause the display screen to display a selection screen with a list of specified commodities from which the specified commodity to which the privilege is to be applied can be selected.

14. The point-of-sale terminal according to claim 9, wherein the privilege associated with the customer is based on an accumulated number of privilege stickers from one or more previous sales transactions.

15. A sales data processing system, comprising:
a server storing privilege information indicating a privilege associated with a customer for the purchase of a specified commodity; and
a sales data processing apparatus including:
a communication interface configured to connect to the server; and
a processor configured to:
receive customer identification information for identifying the customer in a sales transaction;
receive commodity identification information for identifying a commodity in the sales transaction;
acquire privilege information from the server indicating the privilege associated with the customer for the purchase of the specified commodity;
receive a privilege use instruction for declaring an intention by the customer to purchase the specified commodity using the privilege; and
register the commodity in the sales transaction at a discounted price if the commodity is the specified commodity, the privilege use instruction declares the intention to purchase the specified commodity using the privilege, and the privilege associated with the customer satisfies a privilege condition set for the specified commodity.

16. The sales data processing system according to claim 15, wherein the processor is further configured to:
determine whether the privilege associated with the customer satisfies the privilege condition for the specified commodity.

17. The sales data processing system according to claim 15, wherein the privilege information from the server indicates whether the privilege associated with the customer satisfies the privilege condition for the specified commodity.

18. The sales data processing system according to claim 15, the sales data processing apparatus further comprising:
a barcode reader configured to read a barcode on the commodity and supply the commodity identification information.

19. The sales data processing system according to claim 15, the sales data processing apparatus further comprising:
a card reader configured to read a membership card and supply the customer identification information.

20. The sales data processing system according to claim 15, wherein the privilege associated with the customer is based on an accumulated number of privilege stickers from one or more previous sales transactions.
